(19) United States
(12) Patent Application Publication
(10) Pub. No.: US 2021/0398061 A1
(43) Pub. Date: Dec. 23, 2021

(54) REINFORCEMENT LEARNING SYSTEMS AND METHODS FOR INVENTORY CONTROL AND OPTIMIZATION

(71) Applicant: Amadeus S.A.S., Biot (FR)

(72) Inventors: Rodrigo Alejandro Acuna Agost, Vallauris Golfe-Juan (FR); Thomas Fiig, Copenhagen (DK); Nicolas Bondoux, Antibes (FR); Anh-Quan Nguyen, Villeneuve-Loubet (FR)

(21) Appl. No.: 17/287,675

(22) PCT Filed: Oct. 21, 2019
(86) PCT No.: PCT/EP2019/078491

§ 371 Date: Apr. 22, 2021

(30) Foreign Application Priority Data
Oct. 31, 2018 (FR) 1860075

(51) Int. Cl. G06Q 10/08; G06N 3/08; G06Q 10/06; G06Q 30/02; G06F 30/20

(52) U.S. Cl. CPC G06Q 10/087; G06N 3/08; G06Q 10/06315; G06F 30/20; G06Q 30/0201; G06Q 10/067; G06Q 10/06313

(57) ABSTRACT

Methods of reinforcement learning for a resource management agent. Responsive to generated actions, corresponding observations are received. Each observation comprises a transition in a state associated with an inventory and an associated reward in the form of revenues generated from perishable resource sales. A randomized batch of observations is periodically sampled according to a prioritized replay sampling algorithm. A probability distribution for selection of observations within the batch is progressively adapted. Each batch of observations is used to update weight parameters of a neural network that comprises an approximator of the resource management agent, such that when provided with an input inventory state and an input action, an output of the neural network more closely approximates a true value of generating the input action while in the input inventory state. The neural network may be used to select each generated action depending upon a corresponding state associated with the inventory.

### FIELD OF THE INVENTION

The present invention relates to technical methods and systems for improving inventory control and optimization. In particular, embodiments of the invention employ machine learning technologies, and specifically reinforcement learning, in the implementation of improved revenue management systems.

### BACKGROUND TO THE INVENTION

Inventory systems are employed in many industries to control availability of resources, for example through pricing and revenue management, and any associated calculations. Inventory systems enable customers to purchase or book available resources or commodities offered by providers. In addition, inventory systems allow providers to manage available resources and maximize revenue and profit in provision of these resources to customers.

In this context, the term ‘revenue management’ refers to the application of data analytics to predict consumer behaviour and to optimise product offerings and pricing to maximise revenue growth. Revenue management and pricing is of particular importance in the hospitality, travel, and transportation industries, all of which are characterised by ‘perishable inventory’, i.e. unoccupied spaces, such as rooms or seats, represent unrecoverable lost revenue once the horizon for their use has passed. Pricing and revenue management are among the most effective ways that operators in these industries can improve their business and financial performance. Significantly, pricing is a powerful tool in capacity management and load balancing. As a result, recent decades have seen the development of sophisticated automated Revenue Management Systems in these industries.

By way of example, an airline Revenue Management System (RMS) is an automated system that is designed to maximise flight revenue generated from all available seats over a reservation period (typically one year). The RMS is used to set policies regarding seat availability and pricing (air fares) over time in order to achieve maximum revenue.

A conventional RMS is a modelled system, i.e. it is based upon a model of revenues and reservations. The model is specifically built to simulate operations and, as a result, necessarily embodies numerous assumptions, estimations, and heuristics. These include prediction/modelling of customer behaviour, forecasting of demand (volume and pattern), optimisation of occupation of seats on individual flight legs as well as across the entire network, and overbooking.

However, the conventional RMS has a number of disadvantages and limitations. Firstly, RMS is dependent upon assumptions that may be invalid. For example, RMS assumes that the future is accurately described by the past, which may not be the case if there are changes in the business environment (e.g. new competitors), shifts in demand and consumer price-sensitivity, or changes in customer behaviour. It also assumes that customer behaviour is rational. Additionally, conventional RMS models treat the market as a monopoly, under an assumption that the actions of competitors are implicitly accounted for in customer behaviour.

A further disadvantage of the conventional approach to RMS is that there is generally an interdependence between the model and its inputs, such that any change in the available input data requires that the model be modified or rebuilt to take advantage or account of the new or changed information. Additionally, without human intervention modelled systems are slow to react to changes in demand that are poorly represented, or unrepresented, in historical data on which the model is based.

It would therefore be desirable to develop improved systems that are able to overcome, or at least mitigate, one or more of the disadvantages and limitations of conventional RMS.

### SUMMARY OF THE INVENTION

Embodiments of the invention implement an approach to revenue management based upon machine learning (ML) techniques. This approach advantageously includes providing a reinforcement learning (RL) system which uses observations of historical data and live data (e.g. inventory snapshots) to generate outputs, such as recommended pricing and/or availability policies, in order to optimize revenues.

Reinforcement learning is an ML technique that can be applied to sequential decision problems such as, in embodiments of the invention, determining the policies to be set at any one point in time with the objective of optimizing revenue over the longer term, based upon observations of the current state of the system, i.e. reservations and available inventory over a predetermined reservation period. Advantageously, an RL agent takes actions based solely upon observations of the state of the system, and receives feedback in the form of a successor state reached in consequence of past actions, and a reinforcement or ‘reward’, e.g. a measure of how effective those actions have been in achieving the objective. The RL agent thus ‘learns’, over time, the optimum actions to take in any given state in order to achieve the objective, such as a price/fare and availability policy to be set so as to maximise revenue over the reservation period.

More particularly, in one aspect the present invention provides a method of reinforcement learning for a resource management agent in a system for managing an inventory of perishable resources having a sales horizon, while seeking to optimize revenue generated therefrom, wherein the inventory has an associated state comprising a remaining availability of the perishable resources and a remaining period of the sales horizon, the method comprising:

generating a plurality of actions, each action comprising publishing data defining a pricing schedule in respect of perishable resources remaining in the inventory;

receiving, responsive to the plurality of actions, a corresponding plurality of observations, each observation comprising a transition in the state associated with the inventory and an associated reward in the form of revenues generated from sales of the perishable resources;

storing the received observations in a replay memory store;

periodically sampling, from the replay memory store, a randomised batch of observations according to a prioritised replay sampling algorithm wherein, throughout a training epoch, a probability distribution for selection of observations within the randomised batch is progressively adapted from a distribution favouring selection of observations corresponding with transitions close to a terminal state towards a distribution favouring selection of observations corresponding with transitions close to an initial state; and

using each randomised batch of observations to update weight parameters of a neural network that comprises an action-value function approximator of the resource management agent, such that when provided with an input inventory state and an input action, an output of the neural network more closely approximates a true value of generating the input action while in the input inventory state,

wherein the neural network may be used to select each of the plurality of actions generated depending upon a corresponding state associated with the inventory.

Advantageously, benchmarking simulations have demonstrated that an RL resource management agent embodying the method of the invention provides improved performance over prior art resource management systems, given observation data from which to learn. Furthermore, since the observed state transitions and rewards will change along with any changes in the market for the perishable resources, the agent is able to react to such changes without human intervention. The agent does not require a model of the market or of consumer behaviour in order to adapt, i.e. it is model-free, and free of any corresponding assumptions.

Advantageously, in order to reduce the amount of data required for initial training of the RL agent, embodiments of the invention employ a deep learning (DL) approach. In particular, the neural network may be a deep neural network (DNN).

In embodiments of the invention, the neural network may be initialised by a process of knowledge transfer (i.e. a form of supervised learning) from an existing revenue management system to provide a ‘warm start’ for the resource management agent. A method of knowledge transfer may comprise steps of:

determining a value function associated with the existing revenue management system, wherein the value function maps states associated with the inventory to corresponding estimated values;

translating the value function to a corresponding translated action-value function adapted to the resource management agent, wherein the translation comprises matching a time step size to a time step associated with the resource management agent and adding action dimensions to the value function;

sampling the translated action-value function to generate a training data set for the neural network; and

training the neural network using the training data set.

Advantageously, by employing a knowledge transfer process, the resource management agent may require a substantially reduced volume of additional data in order to learn optimal, or near-optimal, policy actions. Initially, at least, such an embodiment of the invention performs equivalently to the existing revenue management system, in the sense that it generates the same actions in response to the same inventory state. Subsequently, the resource management agent may learn to outperform the existing revenue management system from which its initial knowledge was transferred.

In some embodiments, the resource management agent may be configured to switch between action-value function approximation using the neural network and a Q-learning approach based upon a tabular representation of the action-value function. In particular, a switching method may comprise:

for each state and action, computing a corresponding action value using the neural network, and populating an entry in an action-value look-up table with the computed value; and

switching to a Q-learning operation mode using the action-value look-up table.

A further method for switching back to neural-network-based action-value function approximation may comprise:

sampling the action-value look-up table to generate a training data set for the neural network;

training the neural network using the training data set; and

switching to a neural network function approximation operation model using the trained neural network.

Advantageously, providing a capability to switch between neural-network based function approximation and tabular Q-learning operation modes enables the benefits of both approaches to be obtained as desired. Specifically, in the neural network operation mode, the resource management agent is able to learn and adapt to changes using far smaller quantities of observed data when compared to the tabular Q-learning mode, and can efficiently continue to explore alternative strategies online by ongoing training and adaptation using experience replay methods. However, in a stable market, the tabular Q-learning mode may enable the resource management agent to more-effectively exploit the knowledge embodied in the action-value table.

While embodiments of the invention are able to operate, learn and adapt on-line, using live observations of inventory state and market data, it is advantageously also possible to train and benchmark an embodiment using a market simulator. A market simulator may include a simulated demand generation module, a simulated reservation system, and a choice simulation module. The market simulator may further include simulated competing inventory systems.

In another aspect, the invention provides a system for managing an inventory of perishable resources having a sales horizon, while seeking to optimize revenue generated therefrom, wherein the inventory has an associated state comprising a remaining availability of the perishable resources and a remaining period of the sales horizon, the system comprising:

a computer-implemented resource management agent module;

a computer-implemented neural network module comprising an action-value function approximator of the resource management agent;

a replay memory module; and

a computer-implemented learning module,

wherein the resource management agent module is configured to:
generate a plurality of actions, each action being determined by querying the neural network module using a current state associated with the inventory and comprising publishing data defining a pricing schedule in respect of perishable resources remaining in the inventory;
receive, responsive to the plurality of actions, a corresponding plurality of observations, each observation comprising a transition in the state associated with the inventory and an associated reward in the form of revenues generated from sales of the perishable resources; and
store, in the replay memory module, the received observations, wherein the learning module is configured to:
periodically sample, from the replay memory store, a randomised batch of observations according to a prioritised replay sampling algorithm wherein, throughout a training epoch, a probability distribution for selection of observations within the randomised batch is progressively adapted from a distribution favouring selection of observations corresponding with transitions close to a terminal state towards a distribution favouring selection of observations corresponding with transitions close to an initial state; and
use each randomised batch of observations to update weight parameters of the neural network module, such that when provided with an input inventory state and an input action, an output of the neural network module more closely approximates a true value of generating the input action while in the input inventory state.

In another aspect, the invention provides a computing system for managing an inventory of perishable resources having a sales horizon, while seeking to optimize revenue generated therefrom, wherein the inventory has an associated state comprising a remaining availability of the perishable resources and a remaining period of the sales horizon, the system comprising:

a processor;

at least one memory device accessible by the processor; and

a communications interface accessible by the processor,

wherein the memory device contains a replay memory store and a body of program instructions which, when executed by the processor, cause the computing system to implement a method comprising steps of:
generating a plurality of actions, each action comprising publishing, via the communications interface, data defining a pricing schedule in respect of perishable resources remaining in the inventory;
receiving, via the communications interface and responsive to the plurality of actions, a corresponding plurality of observations, each observation comprising a transition in the state associated with the inventory and an associated reward in the form of revenues generated from sales of the perishable resources;
storing the received observations in the replay memory store;
periodically sampling, from the replay memory store, a randomised batch of observations according to a prioritised replay sampling algorithm wherein, throughout a training epoch, a probability distribution for selection of observations within the randomised batch is progressively adapted from a distribution favouring selection of observations corresponding with transitions close to a terminal state towards a distribution favouring selection of observations corresponding with transitions close to an initial state; and
using each randomised batch of observations to update weight parameters of a neural network that comprises an action-value function approximator of the resource management agent, such that when provided with an input inventory state and an input action, an output of the neural network more closely approximates a true value of generating the input action while in the input inventory state,
wherein the neural network may be used to select each of the plurality of actions generated depending upon a corresponding state associated with the inventory.

In yet another aspect, the invention provides a computer program product comprising a tangible computer-readable medium having instructions stored thereon which, when executed by a processor implement a method of reinforcement learning for a resource management agent in a system for managing an inventory of perishable resources having a sales horizon, while seeking to optimize revenue generated therefrom, wherein the inventory has an associated state comprising a remaining availability of the perishable resources and a remaining period of the sales horizon, the method comprising:

generating a plurality of actions, each action comprising publishing data defining a pricing schedule in respect of perishable resources remaining in the inventory;

receiving, responsive to the plurality of actions, a corresponding plurality of observations, each observation comprising a transition in the state associated with the inventory and an associated reward in the form of revenues generated from sales of the perishable resources;

storing the received observations in a replay memory store;

periodically sampling, from the replay memory store, a randomised batch of observations according to a prioritised replay sampling algorithm wherein, throughout a training epoch, a probability distribution for selection of observations within the randomised batch is progressively adapted from a distribution favouring selection of observations corresponding with transitions close to a terminal state towards a distribution favouring selection of observations corresponding with transitions close to an initial state; and

using each randomised batch of observations to update weight parameters of a neural network that comprises an action-value function approximator of the resource management agent, such that when provided with an input inventory state and an input action, an output of the neural network more closely approximates a true value of generating the input action while in the input inventory state,

wherein the neural network may be used to select each of the plurality of actions generated depending upon a corresponding state associated with the inventory.

Further aspects, advantages, and features of embodiments of the invention will be apparent to persons skilled in the relevant arts from the following description of various embodiments. It will be appreciated, however, that the invention is not limited to the embodiments described, which are provided in order to illustrate the principles of the invention as defined in the foregoing statements, and to assist skilled persons in putting these principles into practical effect.

### BRIEF DESCRIPTION OF THE DRAWINGS

Embodiments of the invention will now be described with reference to the accompanying drawings, in which like reference numerals refer to like features, and wherein:

FIG. 1 is a block diagram illustrating an exemplary networked system including an inventory system embodying the invention;

FIG. 2 is functional block diagram of an exemplary inventory system embodying the invention;

FIG. 3 is a block diagram of an air travel market simulator suitable for training and/or benchmarking a reinforcement learning revenue management system embodying the invention;

FIG. 4 is a block diagram of a reinforcement learning revenue management system embodying the invention that employs a tabular Q-learning approach;

FIG. 5 shows a chart illustrating performance of the Q-learning reinforcement learning revenue management system of FIG. 4 when interacting with a simulated environment;

FIG. 6A is a block diagram of a reinforcement learning revenue management system embodying the invention that employs a deep Q-learning approach;

FIG. 6B is a flowchart illustrating a method of sampling and update, according to a prioritised reply approach embodying the invention;

FIG. 7 shows a chart illustrating performance of the deep Q-learning reinforcement learning revenue management system of FIG. 6 when interacting with a simulated environment;

FIG. 8A is a flowchart illustrating a method of knowledge transfer for initialising a reinforcement learning revenue management system embodying the invention;

FIG. 8B is a flowchart illustrating additional detail of the knowledge transfer method of FIG. 8A;

FIG. 9 is a flowchart illustrating a method of switching from deep Q-learning operation to tabular Q-learning operation in a reinforcement learning revenue management system embodying the invention;

FIG. 10 is a chart showing a performance benchmark of prior art revenue management algorithms using the market simulator of FIG. 3;

FIG. 11 is a chart showing a performance benchmark of a reinforcement learning revenue management system embodying the invention using the market simulator of FIG. 3;

FIG. 12 is a chart showing booking curves corresponding with the performance benchmark of FIG. 10;

FIG. 13 is a chart showing booking curves corresponding with the performance benchmark of FIG. 11; and

FIG. 14 is a chart illustrating the effect of fare policies selected by a prior art revenue management system and a reinforcement learning revenue management system embodying the invention using the market simulator of FIG. 3.

### DESCRIPTION OF EMBODIMENTS

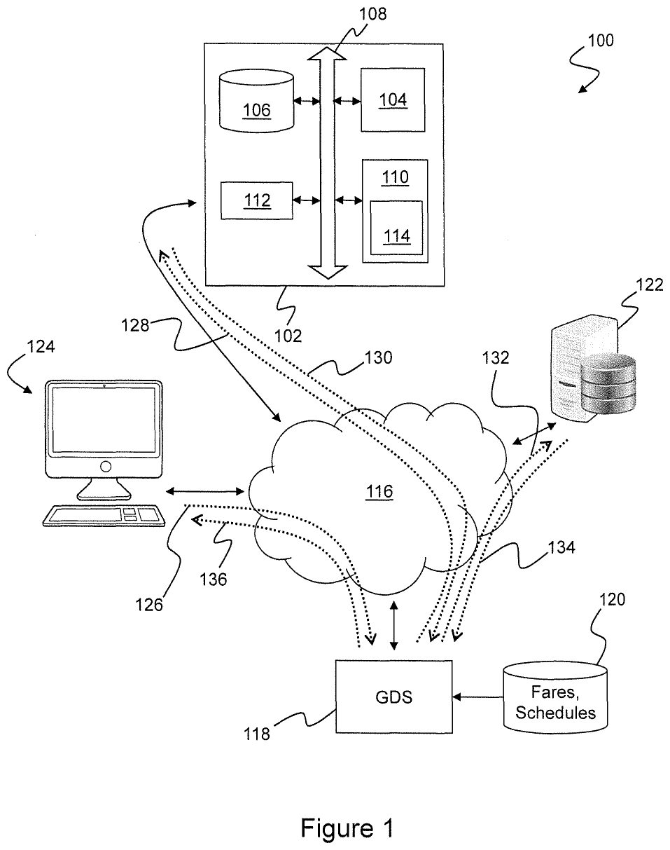

FIG. 1 is a block diagram illustrating an exemplary networked system 100 including an inventory system 102 embodying the invention. In particular, the inventory system 102 comprises a reinforcement learning (RL) system configured to perform revenue optimisation in accordance with an embodiment of the invention. For concreteness, an embodiment of the invention is described with reference to an inventory and revenue optimization system for the sale and reservation of airline seats, wherein the networked system 100 generally comprises an airline booking system, and the inventory system 102 comprises an inventory system of a particular airline. However, it will be appreciated that this is merely one example, to illustrate the system and method, and it will be appreciated that further embodiments of the invention may be applied to inventory and revenue management systems, other than those relating to the sale and reservation of airline seats.

The airline inventory system 102 may comprise a computer system having a conventional architecture. In particular, the airline inventory system 102, as illustrated, comprises a processor 104. The processor 104 is operably associated with a non-volatile memory/storage device 106, e.g. via one or more data/address busses 108 as shown. The non-volatile storage 106 may be a hard disk drive, and/or may include a solid-state non-volatile memory, such as ROM, flash memory, solid-state drive (SSD), or the like. The processor 104 is also interfaced to volatile storage 110, such as RAM, which contains program instructions and transient data relating to the operation of the airline inventory system 102.

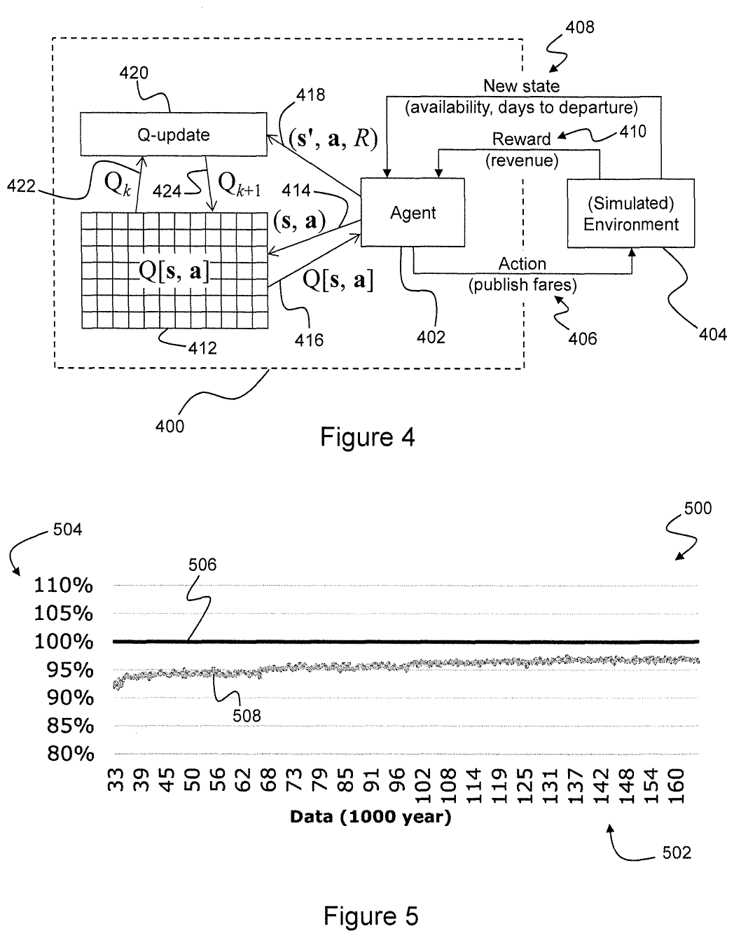

In a conventional configuration, the storage device 106 maintains known program and data content relevant to the normal operation of the airline inventory system 102. For example, the storage device 106 may contain operating system programs and data, as well as other executable application software necessary for the intended functions of the airline inventory system 102. The storage device 106 also contains program instructions which, when executed by the processor 104, cause the airline inventory system 102 to perform operations relating to an embodiment of the present invention, such as are described in greater detail below, and with reference to FIGS. 4 to 14 in particular. In operation, instructions and data held on the storage device 106 are transferred to volatile memory 110 for execution on demand.

The processor 104 is also operably associated with a communications interface 112 in a conventional manner. The communications interface 112 facilitates access to a wide-area data communications network, such as the Internet 116.

In use, the volatile storage 110 contains a corresponding body 114 of program instructions transferred from the storage device 106 and configured to perform processing and other operations embodying features of the present invention. The program instructions 114 comprise a technical contribution to the art developed and configured specifically to implement an embodiment of the invention, over and above well-understood, routine, and conventional activity in the art of revenue optimization and machine learning systems, as further described below, particularly with reference to FIGS. 4 to 14.

With regard to the preceding overview of the airline inventory system 102, and other processing systems and devices described in this specification, terms such as ‘processor’, ‘computer’, and so forth, unless otherwise required by the context, should be understood as referring to a range of possible implementations of devices, apparatus and systems comprising a combination of hardware and software. This includes single-processor and multi-processor devices and apparatus, including portable devices, desktop computers, and various types of server systems, including cooperating hardware and software platforms that may be co-located or distributed. Physical processors may include general purpose CPUs, digital signal processors, graphics processing units (GPUs), and/or other hardware devices suitable for efficient execution of required programs and algorithms. As will be appreciated by persons skilled in the art, GPUs in particular may be employed for high-performance implementation of the deep neural networks comprising various embodiments of the invention, under control of one or more general purpose CPUs.

Computing systems may include conventional personal computer architectures, or other general-purpose hardware platforms. Software may include open-source and/or commercially-available operating system software in combination with various application and service programs. Alternatively, computing or processing platforms may comprise custom hardware and/or software architectures. For enhanced scalability, computing and processing systems may comprise cloud computing platforms, enabling physical hardware resources to be allocated dynamically in response to service demands. While all of these variations fall within the scope of the present invention, for ease of explanation and understanding the exemplary embodiments are described herein with illustrative reference to single-processor general-purpose computing platforms, commonly available operating system platforms, and/or widely available consumer products, such as desktop PCs, notebook or laptop PCs, smartphones, tablet computers, and so forth.

In particular, the terms ‘processing unit’ and ‘module’ are used in this specification to refer to any suitable combination of hardware and software configured to perform a particular defined task, such as accessing and processing offline or online data, executing training steps of a reinforcement learning model and/or of deep neural networks or other function approximators within such a model, or executing pricing and revenue optimization steps. Such a processing unit or module may comprise executable code executing at a single location on a single processing device, or may comprise cooperating executable code modules executing in multiple locations and/or on multiple processing devices. For example, in some embodiments of the invention, revenue optimization and reinforcement learning algorithms may be carried out entirely by code executing on a single system, such as the airline inventory system 102, while in other embodiments corresponding processing may be performed in a distributed manner over a plurality of systems.

Software components, e.g. program instructions 114, embodying features of the invention may be developed using any suitable programming language, development environment, or combinations of languages and development environments, as will be familiar to persons skilled in the art of software engineering. For example, suitable software may be developed using the C programming language, the Java programming language, the C++ programming language, the Go programming language, the Python programming language, the R programming language, and/or other languages suitable for implementation of machine learning algorithms. Development of software modules embodying the invention may be supported by the use of machine learning code libraries such as the TensorFlow, Torch, and Keras libraries. It will be appreciated by skilled persons, however, that embodiments of the invention involve the implementation of software structures and code that are not well-understood, routine, or conventional in the art of machine learning systems, and that while pre-existing libraries may assist implementation, they require specific configuration and extensive augmentation (i.e. additional code development) in order to realise various benefits and advantages of the invention and implement the specific structures, processing, computations, and algorithms described below, particularly with reference to FIGS. 4 to 14.

The foregoing examples of languages, environments, and code libraries are not intended to be limiting, and it will be appreciated that any convenient languages, libraries, and development systems may be employed, in accordance with system requirements. The descriptions, block diagrams, flowcharts, equations, and so forth, presented in this specification are provided, by way of example, to enable those skilled in the arts of software engineering and machine learning to understand and appreciate the features, nature, and scope of the invention, and to put one or more embodiments of the invention into effect by implementation of suitable software code using any suitable languages, frameworks, libraries and development systems in accordance with this disclosure without exercise of additional inventive ingenuity.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media may include volatile and non-volatile, and removable and non-removable, tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. While a computer readable storage medium may not comprise transitory signals per se (e.g. radio waves or other propagating electromagnetic waves, electromagnetic waves propagating through a transmission media such as a waveguide, or electrical signals transmitted through a wire), computer readable program instructions may be downloaded via such transitory signals to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flowcharts, sequence diagrams, and/or block diagrams.

Returning to the discussion of FIG. 1, the airline booking system 100 includes a global distribution system (GDS) 118, which includes a reservation system (not shown), and which is able to access a database 120 of fares and schedules of various airlines for which reservations may be made. Also shown is an inventory system 122 of an alternative airline. While a single alternative airline inventory system 122 is shown in FIG. 1, by way of illustration, it will be appreciated that the airline industry is highly competitive, and in practice the GDS 118 is able to access fares and schedules, and perform reservations, for a large number of airlines, each of which has its own inventory system. Customers, which may be individuals, booking agents, or any other corporate or personal entities, access the reservation services of the GDS 118 over the network 116, e.g. via customer terminals 124 executing corresponding reservation software.

In accordance with a common use-case, an incoming request 126 from a customer terminal 124 is received at the GDS 118. The incoming request 126 includes all expected information for a passenger wishing to travel to a destination. For example, the information may include departure point, arrival point, date of travel, number of passengers, and so forth. The GDS 118 accesses the database 120 of fares and schedules to identify one or more itineraries that may satisfy the customer requirements. The GDS 118 may then generate one or more booking requests in respect of a selected itinerary. For example, as shown in FIG. 1 a booking request 128 is transmitted to the inventory system 102, which processes the request and generates a response 130 indicating whether the booking is accepted or rejected. Also illustrated is the transmission of a further booking request 132 to the alternative airline inventory system 122, and a corresponding accept/reject response 134. A booking confirmation message 136 may then be transmitted by the GDS 118 back to the customer terminal 124.

As is well-known in the airline industry, due to the competitive environment most airlines offer a number of different travel classes (e.g. economy/coach, premium economy, business and first class), and within each travel class there may be a number of fare classes having different pricing and conditions. A primary function of revenue management and optimization systems is therefore to control availability and pricing of these different fare classes over the time period between the opening of bookings and departure of a flight, in an effort to maximise the revenue generated for the airline by the flight. The most sophisticated conventional RMS employs a dynamic programming (DP) approach to solve a model of the revenue generation process that takes into account seat availability, time-to-departure, marginal value and marginal cost of each seat, models of customer behaviour (e.g. price-sensitivity or willingness to pay), and so forth, in order to generate, at a particular point in time, a policy comprising a specific price for each one of a set of available fare classes. In a common implementation, each price may be selected from a corresponding set of fare points, which may include ‘closed’, i.e. an indication that the fare class is no longer available for sale. Typically, as demand rises and/or supply falls (e.g. as the time of departure approaches) the policy generated by the RMS from its solution to the model changes, such that the selected price points for each fare class increase, and the cheaper (and more restricted) classes are ‘closed’.

Embodiments of the present invention replace the model-based dynamic programming approach of the conventional RMS with a novel approach based upon reinforcement learning (RL).

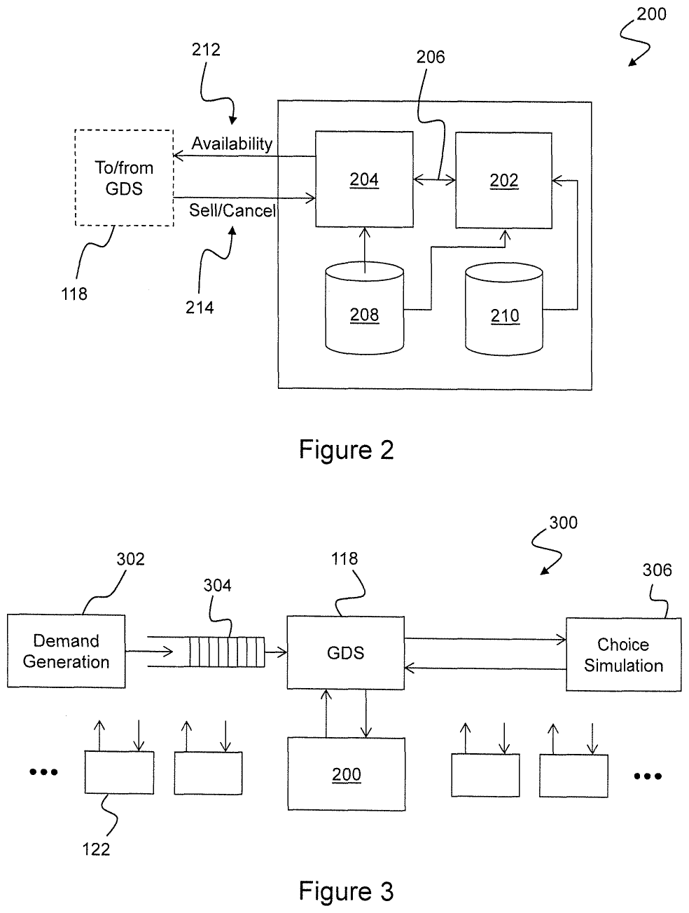

A functional block diagram of an exemplary inventory system 200 is illustrated in FIG. 2. The inventory system 200 includes a revenue management module 202, which is responsible for generating fare policies, i.e. pricing for each one of a set of available fare classes on each flight that is available for reservation at a given point in time. In general, the revenue management module 202 may implement a conventional DP-based RMS (DP-RMS), or some other algorithm for determining policies. In embodiments of the present invention, the revenue management module implements an RL-based revenue management system (RL-RMS), such as is described in detail below with reference to FIGS. 4 to 14.

In operation, the revenue management module 202 communicates with an inventory management module 204 via a communications channel 206. The revenue management module 202 is thereby able to receive information in relation to available inventory (i.e. remaining unsold seats on open flights) from the inventory management module 204, and to transmit fare policy updates to the inventory management module 204. Both the inventory management module 204 and the revenue management module are able to access fare data 208, including information defining available price points and conditions set by the airline for each fare class. The revenue management module 202 is also configured to access historical data 210 of flight reservations, which embodies information about customer behaviour, price-sensitivity, historical demand, and so forth.

The inventory management module 204 receives requests 214 from the GDS 118, e.g. for bookings, changes, and cancellations. It responds 212 to these requests by accepting or rejecting them, based upon the current policies set by the revenue management module 202 and corresponding fare information stored in the fare database 208.

In order to compare the performance of different revenue management approaches and algorithms, and to provide a training environment for an RL-RMS, it is beneficial to implement an air travel market simulator. A block diagram of such a simulator 300 is shown in FIG. 3. The simulator 300 includes a demand generation module 302, which is configured to generate simulated customer requests. The simulated requests may be generated to be statistically similar to observed demand over a relevant historical period, may be synthesised in accordance with some other pattern of demand, and/or may be based upon some other demand model, or combination of models. The simulated requests are added to an event queue 304, which is served by a GDS 118. The GDS 118 makes corresponding booking requests to the inventory system 200 and/or to any number of simulated competing airline inventory systems 122. Each competing airline inventory system 122 may be based upon a similar functional model to the inventory system 200, but may implement a different approach to revenue management, e.g. DP-RMS, in its equivalent of the revenue management module 202.

A choice simulation module 306 receives available travel solutions provided by the airline inventory systems 200, 122 from the GDS 118, and generates simulated customer choices. Customer choices may be based upon historical observations of customer reservation behaviour, price-sensitivity, and so forth, and/or may be based upon other models of consumer behaviour.

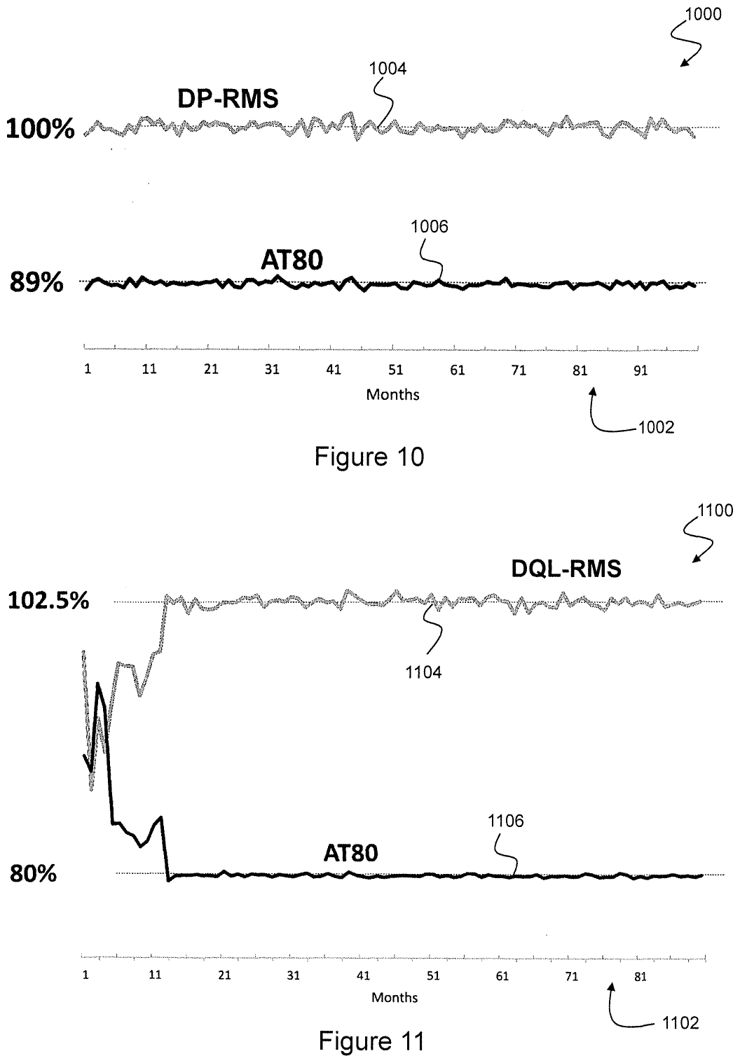

From the perspective of the inventory system 200, the demand generation module 302, event queue 304, GDS 118, choice simulator 306, and competing airline inventory systems 122, collectively comprise a simulated operating environment (i.e. air travel market) in which the inventory system 200 competes for bookings, and seeks to optimize its revenue generation. For the purposes of the present disclosure, this simulated environment is used for the purposes of training an RL-RMS, as described further below with reference to FIGS. 4 to 7, and for comparing the performance of the RL-RMS with alternative revenue management approaches, as described further below with reference to FIGS. 10 to 14. As will be appreciated, however, an RL-RMS embodying the present invention will operate in the same way when interacting with a real air travel market, and is not limited to interactions with a simulated environment.

FIG. 4 is a block diagram of an RL-RMS 400 embodying the invention that employs a Q-learning approach. The RL-RMS 400 comprises an agent 402, which is a software module configured to interact with an external environment 404. The environment 404 may be a real air travel market, or a simulated air travel market such as described above with reference to FIG. 2. In accordance with a well-known model of RL systems, the agent 402 takes actions which influence the environment 404, and observes changes in the state of the environment, and receives rewards, in response to those actions. In particular, the actions 406 taken by the RL-RMS agent 402 comprise the fare policies generated. The state of the environment 408, for any given flight, comprises availability (i.e. the number of unsold seats), and the number of days remaining until departure. The rewards 410 comprise revenue generated from seat reservations. The RL objective of the agent 402 is therefore to determine actions 406 (i.e. policies) for each observed state of the environment that maximise total rewards 410 (i.e. revenue per flight).

The Q-learning RL-RMS 202 maintains an action-value table 412, which comprises value estimates [symbol] [s, a] for each state s and each available action (fare policy) a. In order to determine the action to take in the current state s, the agent 402 is configured to query 414 the action-value table 412 for each available action a, to retrieve the corresponding value estimates [symbol] [s, a], and to select an action based upon some current action policy π. In live operation within a real market, the action policy it may be to select the action a that maximises [symbol] in the current state s (i.e. a ‘greedy’ action policy). However, when training the RL-RMS, e.g. offline using simulated demand, or online using recent observations of customer behaviour, an alternative action policy may be preferred, such as an ‘ε-greedy’ action policy, that balances exploitation of the current action-value data with exploration of actions presently considered to be lower-value, but which may ultimately lead to higher revenues via unexplored states, or due to changes in the market.

After taking an action a, the agent 402 receives a new state s′ and reward R from the environment 404, and the resulting observation (s′, a, R) is passed 418 to a Q-update software module 420. The Q-update module 420 is configured to update the action-value table 412 by retrieving 422 a current estimated value [symbol] ₖ of the state-action pair (s, a) and storing 424 a revised estimate [symbol] ₖ₊₁ based upon the new state s′ and reward R actually observed in response to the action a. The details of suitable Q-learning update steps are well-known to persons skilled in the art of reinforcement learning, and are therefore omitted here to avoid unnecessary additional explication.

FIG. 5 shows a chart 500 of the performance of the Q-learning RL-RMS 400 interacting with a simulated environment 404. The horizontal axis 502 represents the number of years of simulated market data (in thousands), while the vertical axis 504 represents the percentage of target revenue 506 achieved by the RL-RMS 400. The revenue curve 508 shows that the RL-RMS is indeed able to learn to optimize revenue towards the target 506, however its learning rate is extremely slow, and achieves approximately 96% target revenue only after experiencing 160,000 years' worth of simulated data.

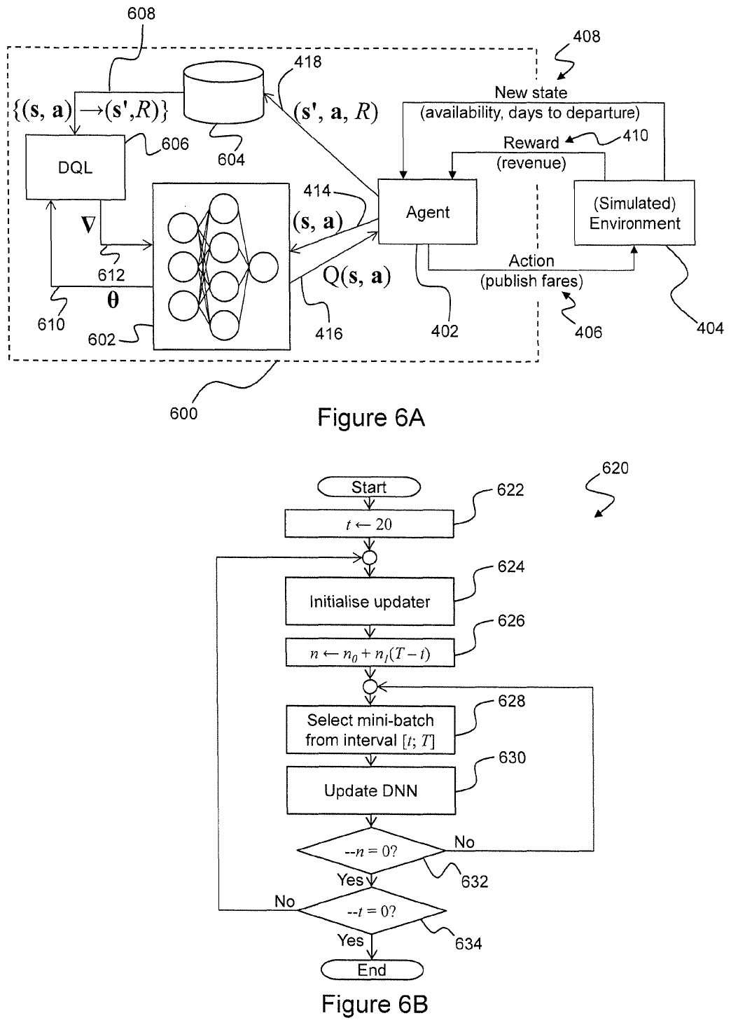

FIG. 6A is a block diagram of an alternative RL-RMS 600 embodying the invention that employs a deep Q-learning (DQL) approach. The interactions of the agent 402 with the environment 404, and the decision-making process of the agent 402, are substantially the same as in the tabular Q-learning RL-RMS, as indicated by use of the same reference numerals, and therefore need not be described again. In the DQL RL-RMS, the action-value table is replaced with a function approximator, and in particular with a deep neural network (DNN) 602. In an exemplary embodiment, for an aircraft having around 200 seats, the DNN 602 comprises four hidden layers, with each hidden layer comprising 100 nodes, fully connected. Accordingly, the exemplary architecture may be defined as (k, 100, 100, 100, 100, n) where k is the length of the state (i.e. k=2 for a state consisting of availability and days-to-departure) and n is the number of possible actions. In an alternative embodiment, the DNN 602 may comprise a duelling network architecture, in which the value network is (k, 100, 100, 100, 100, 1), and the advantage network is (k, 100, 100, 100, 100, n). In simulations, the inventors have found that the use of a duelling network architecture may provide a slight advantage over a single action-value network, however the improvement was not found to be critical to the general performance of the invention.

In the DQL RL-RMS observations of the environment are saved in a replay memory store 604. A DQL software module is configured to sample transitions (s, a)→(s′, R) from the replay memory 604, for use in training the DNN 602. In particular, embodiments of the invention employ a specific form of prioritised experience replay which has been found to achieve good results while using relative small numbers of observed transitions. A common approach in DQL is to sample transitions from a replay memory completely at random, in order to avoid correlations that may prevent convergence of the DNN weights. An alternative known prioritised replay approach samples the transitions with a probability that is based upon a current error estimate of the value function for each state, such that states having a larger error (and thus where the greatest improvements in estimation may be expected) are more likely to be sampled.

The prioritised replay approach employed in embodiments of the present invention is different, and is based upon the observation that a full solution of the revenue optimization problem (e.g. using DP) commences with the terminal state, i.e. at departure of a flight, when the actual final revenue is known, and works backwards through an expanding ‘pyramid’ of possible paths to the terminal state to determine the corresponding value function. In each training step, mini-batches of transitions are sampled from the replay memory according to a statistical distribution that initially prioritises transitions close to the terminal state. Over multiple training steps across a training epoch, the parameters of the distribution are adjusted such that priority shifts over time to transitions that are further from the terminal state. The statistical distribution is nonetheless chosen such that any transition still has a chance of being selected in any batch, such that the DNN continues to learn the action-value function across the entire state space of interest and does not, in effect, ‘forget’ what it has learned about states near the terminal as it gains more knowledge of earlier states.

In order to update the DNN 602, the DQL module 606 retrieves 610 the weight parameters θ of the DNN 602, performs one or more training steps, e.g. using a conventional back-propagation algorithm, using the sampled mini-batches, and then sends 612 an update [symbol] to the DNN 602. Further detail of the method of sampling and update, according to a prioritised reply approach embodying the invention is illustrated in the flowchart 620 shown in FIG. 6B. At step 622, a time index t is initialised to represent a time interval immediately prior to departure. In an exemplary embodiment, the time between opening of bookings and departure is divided into 20 data collection points (DCPs), such that the time of departure T corresponds with t=21, and therefore the initial value of the time index tin the method 620 is t=20. At step 624, parameters of the DNN update algorithm are initialised. In an exemplary embodiment, the Adam update algorithm (i.e. an improved form of stochastic gradient descent) is employed. At step 626, a counter n is initialised, which controls the number of iterations (and mini-batches) used in each update of the DNN. In an exemplary embodiment, the value of the counter is determined using a base value n₀, and a value proportional to the remaining number of time intervals until departure, given by n₁(T−t). Concretely, n₀ may be set to 50 and nᵢ to 20, however in simulation the inventors have found these values not to be especially critical. The basic principle is that as the algorithm moves further back in time (i.e. towards the opening of bookings), the more iterations are used in training the DNN.

At step 628 a mini-batch of samples is randomly selected from those samples in the replay set 604 corresponding with the time period defined by the present index t and the time of departure T. Then, at step 630, one step of gradient descent is taken by the updater using the selected mini-batch. This process is repeated 632 for the time step t until all n iterations have been completed. The time index t is then decremented 634, and if it has not reached zero control returns to step 624.

In an exemplary embodiment, the size of the replay set was 6000 samples, corresponding with data collected from 300 flights over 20 time intervals per flight, however it has been observed that this number is not critical, and a range of values may be used. Furthermore, the mini-batch size was 600, which was determined based on the particular simulation parameters used.

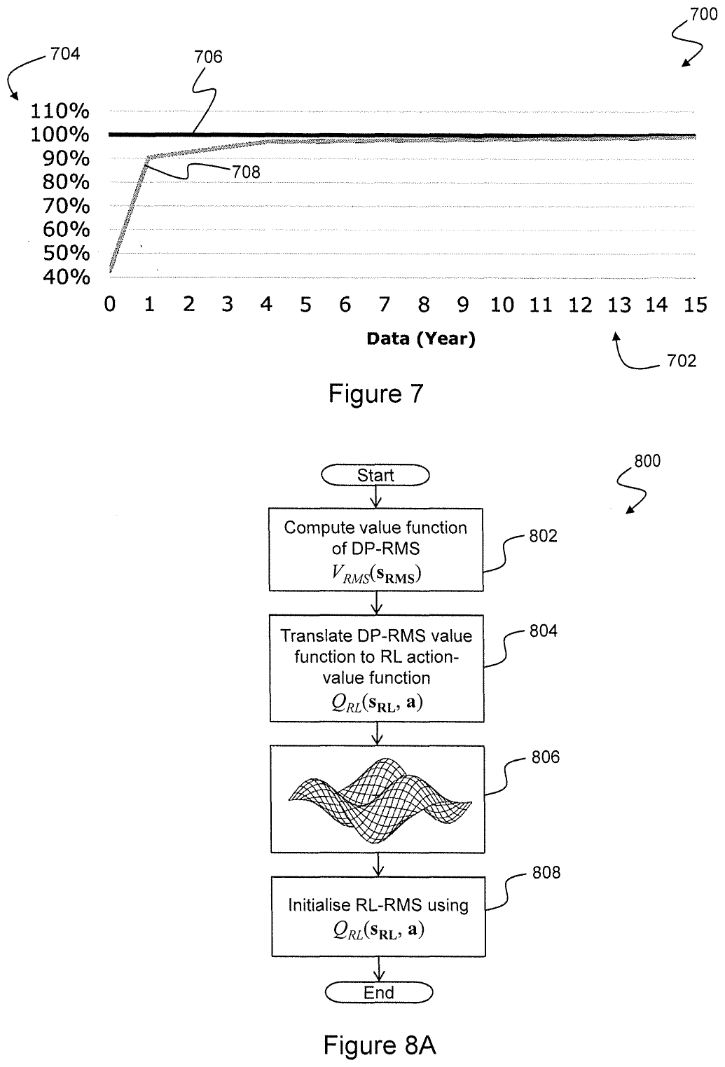

FIG. 7 shows a chart 700 of the performance of the DQL RL-RMS 600 interacting with a simulated environment 404. The horizontal axis 702 represents the number of years of simulated market data, while the vertical axis 704 represents the percentage of target revenue 706 achieved by the RL-RMS 600. The revenue curve 708 shows that the DQL RL-RMS 600 is able to learn to optimize revenue towards the target 706, far more rapidly than the tabular Q-learning RL-RMS 400, achieving around 99% of target revenue with just five years' worth of simulated data, and close to 100% by 15 years' worth of simulated data.

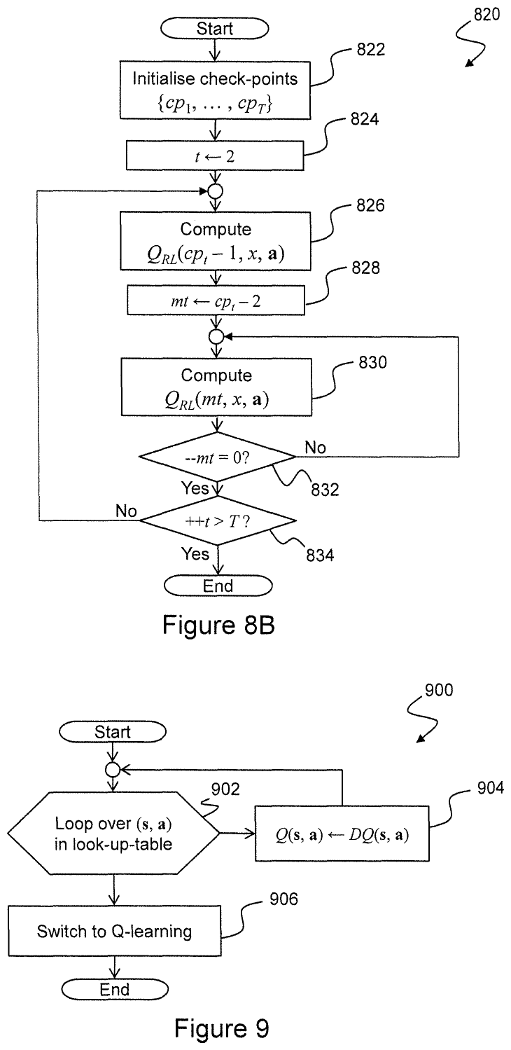

An alternative method of initialising an RL-RMS 400, 600 is illustrated by the flowchart 800 shown in FIG. 8A. The method 800 makes use of an existing RMS, e.g. a DP-RMS, as a source for ‘knowledge transfer’ to an RL-RMS. The goal under this method is that, in a given state s, the RL-RMS should initially generate the same fare policy as would be produced using the source RMS from which the RL-RMS is initialised. The general principle embodied by the process 800 is therefore to obtain an estimate of an equivalent action-value function corresponding with the source RMS, and then use this function to initialise the RL-RMS, e.g. by setting corresponding values of a tabular action-value representation in a Q-learning embodiment, or by supervised training of the DNN in a DQL embodiment.

In the case of a source DP-RMS, however, there are two difficulties to be overcome in performing a translation to an equivalent action-value function. Firstly, a DP-RMS does not employ an action-value function. As a model-based optimization process, DP produces a value function, V_{RMS}(s_{RMS}), based upon the assumption that optimum actions are always taken. From this value function, the corresponding fare pricing can be obtained, and used to compute the fare policy at the time at which the optimization is performed. It is therefore necessary to modify the value function obtained from the DP-RMS to include the action dimension. Secondly, DP employs a time-step in its optimisation procedure that is, in practice, set to a very small value such that there will be at most one booking request expected per time-step. While similarly small time steps could be employed in an RL-RMS system, in practice this is not desirable. For each time step in RL, there must an action and some feedback from the environment. Using small time steps therefore requires significantly more training data and, in practice, the size of the RL time step should be set taking into account the available data and cabin capacity. In practice this is acceptable, because the market and the fare policy do not change rapidly, however this results in an inconsistency between the number of time steps in the DP formula and the RL system. Additionally, an RL-RMS may be implemented to take account of additional state information that is not available to a DP-RMS, such as real-time behaviour of competitors (e.g. lowest price currently offered by competitors). In such embodiments, this additional state information must also be incorporated into the action-value function used to initialise the RL-RMS.

Accordingly, at step 802 of the process 800, the DP formula is used to compute the value function V_{RMS}(s_{RMS}), and at step 804 this is translated to reduce the number of time steps and include additional state and action dimensions, resulting in a translated action-value function [symbol] _{RL}(s_{RMS}, a). This function can be sampled 806 to obtain values for a tabular action-value representation in a Q-learning RL-RMS, and/or to obtain data for supervised training of the DNN in a DQL RL-RMS to approximate the translated action-value function. Thus, at step 808 the sampled data is used to initialise the RL-RMS in the appropriate manner.

FIG. 8B is a flowchart 820 illustrating further details of a knowledge transfer method embodying the invention. The method 820 employs a set of ‘check-points’, {cp₁, . . . , cp_{T}}, to represent the larger time-intervals used in the RL-RMS system. The time between each of these check-points is divided into a plurality of micro-steps m corresponding with the shorter time-intervals used in the DP-RMS system. In the following discussion, the RL time-step index is denoted by t, which varies between 1 and T, while the micro-time-step index is denoted mt, which varies between 0 and MT, where there are defined to be M DP-RMS micro-time-steps in each RL-RMS time-step. In practice, the number of RL time steps may be, for example, around 20. For the DP-RMS, the micro-time-steps may be defined such that there is, for example, a 20% probability that a booking request is received with each interval, such that there may be hundreds, or even thousands, of micro-time-steps within the open booking window.

The general algorithm, according to the flowchart 820, proceeds as follows. First, at step 822, the set of check-points is established. An index t is initialised at step 824, corresponding with the beginning of the second RL-RMS time interval, i.e. cp₂. A pair of nested loops is then executed. In the outer loop, at step 826, an equivalent value of the RL action-value function [symbol] _{RL}(s, a) is computed corresponding with a ‘virtual state’ defined by a time one micro-step prior to the current check-point, and availability x, i.e. s=(cpₜ−1, x). The assumed behaviour of the RL-RMS in this virtual state is based on considering that RL performs an action at each check-point and keeps the same action for all micro-time steps between two consecutive check-points. At step 828, a micro-step index mt is initialised to the immediately preceding micro-step, i.e. cpₜ−2. The inner loop then computes corresponding values of the RL action-value function [symbol] _{RL}(s, a) at step 830 by working backwards from the value computed at step 826. This loop continues until the prior check-point is reached, i.e. when mt reaches zero 832. The outer loop then continues until all RL time intervals have been computed, i.e. when t=T 834.

An exemplary mathematical description of the computations in the process 820 will now be described. In DP-RMS, the DP value function may be expressed as:

V_{RMS}(mt,x)=Maxₐ[lₘₜ*Pₘₜ(a)*(Rₘₜ(a)+V_{RMS}(mt+1,x−1))+(1−lᵢₙₜ*Pₘₜ(a))*V_{RMS}(mt+1,x)] where:
lₘₜ is the probability of having a request at step mt;
Pₘₜ(a) is the probability of receiving a booking from a request at step mt, provided action a;
Rₘₜ(a) is average revenue from a booking at step mt, provided action a.

In practice, lₘₜ and the corresponding micro-time steps are defined using demand forecast volume and arrival pattern (and is treated as time-independent), Pₘₜ(a) is computed based upon a consumer-demand willingness-to-pay distribution (which is time-dependent), Rₘₜ(a) is computed based upon a customer choice model (with time-dependent parameters), and x is provided by the airline overbooking module, which is assumed unchanged between DP-RMS and RL-RMS.

Further:

V_{RL}(cp_{T},x)=0 for all x,

Q_{RL}(cp_{T},x,a)=0 for all x,a

V_{RL}(mt,0)=0 for all mt

Q_{RL}(mt,0,a)=0 for all mt,a.

Then, for all mt=cpₜ−1 (i.e. corresponding with step 826) the equivalent value of the RL action-value function may be computed as:

Q_{RL}(mt,x,a)=lₘₜ*Pₘₜ(a)*(Rₘₜ(a)+V_{RL}(mt+1,x−1))+(1−lᵢₙₜ*Pₘₜ(a))*V_{RL}(mt+1,x)

where V_{RL}(mt,x)=MaxₐQ_{RL}(mt,x,a)

Further, for all cpₜ₋₁≤mt<cpₜ−1 (i.e. corresponding with step 830) the equivalent value of the RL action-value function may be computed as:

Q_{RL}(mt,x,a)=lₘₜ*Pₘₜ(a)*(Rₘₜ(a)+Q_{RL}(mt+1,x−1,a))+(1−lₘₜ*Pₘₜ(a))*Q_{RL}(mt+1,x,a)

Accordingly, taking values oft at the check-points, the table Q(t, x, a) is obtained, which may be used to initialise the neural network at step 808 in a supervised fashion. In practice, it has been found that the DP-RMS and RL-RMS value tables are slightly different. However, they result in policies that are around 99% matched in simulations, with revenues obtained from those policies also almost identical.

Advantageously, employing the process 800 not only provides a valid starting point for RL, which is therefore expected initially to perform equivalently to the existing DP-RMS, but also stabilises subsequent training of the RL-RMS. Function approximation methods, such as the use of a DNN, generally have the property that training not only modifies the output of the known states/actions, but of all states/actions, including those that have not been observed in the historical data. This can be beneficial, in that it takes advantage of the fact that similar states/actions are likely to have similar values, however during training it can also result in large changes in Q-values of some states/actions that produce spurious optimal actions. By employing an initialisation process 800, all of the initial Q-values (and DNN parameters, in DQL RL-RMS embodiments) are set to meaningful values, thus reducing the incidence of spurious local maxima during training.

In the above discussion, Q-learning RL-RMS and DQL RL-RMS have been described as discrete embodiments of the invention. In practice, however, it is possible to combine both approaches in a single embodiment in order to obtain the benefits of each. As has been shown, DQL RL-RMS is able to learn and adapt to changes using far smaller quantities of data than Q-learning RL-RMS, and can efficiently continue to explore alternative strategies online by ongoing training and adaptation using experience replay methods. However, in a stable market, Q-learning is able to effectively exploit the knowledge embodied in the action-value table. It may therefore be desirable, from time-to-time, to switch between Q-learning and DQL operation of an RL-RMS.

FIG. 9 is a flowchart 900 illustrating a method of switching from DQL operation to Q-learning operation. The method 900 includes looping 902 over all discrete values of s and a making up the Q-learning look-up table, and evaluating 904 the corresponding 0-values using the deep Q-learning DNN. With the table thus populated with values corresponding precisely with the current state of the DNN, the system switches to Q-learning at step 906.

The reverse process, i.e. switching from Q-learning to DQL, is also possible, and operates in an analogous manner to the sampling 806 and initialisation 808 steps of the process 800. In particular, the current Q-values in the Q-learning look-up table are used as samples of the action-value function to be approximated by the DQL DNN, and used as a source of data for supervised training of the DNN. Once the training has converged, the system switches back to DQL using the trained DNN.

FIGS. 10 to 14 show charts of market simulation results illustrating the performance of an exemplary embodiment of the RL-RMS in simulations using the simulation model 300, in the presence of competitive systems 122 employing alternative RMS approaches. For all simulations, the main parameters are: a flight capacity of 50 seats; a ‘fenceless’ fare structure having 10 fare classes; revenue management based on 20 data collection points (DCP) over a 52-week horizon; and assuming two customer segments with different price-sensitivity characteristics (i.e. FRat5 curves). Three different revenue management systems are simulated: DP-RMS; DQL-RMS; and AT80, a less sophisticated revenue management algorithm that may be employed by a low-cost airline, which adjusts booking limits as an ‘accordion’ with an objective of achieving a load factor target of 80 percent.

FIG. 10 shows a chart 1000 of comparative performance of DP-RMS versus AT80 within the simulated market. The horizontal axis 1002 represents operating time (in months). Revenue is benchmarked relative to the DP-RMS target, and thus the performance of DP-RMS, indicated by the upper curve 1004, fluctuates around 100% throughout the simulated period. In competition with DP-RMS, the AT80 algorithm consistently achieves around 89% of the benchmark revenue, as shown by the lower curve 1006.

FIG. 11 shows a chart 1100 of comparative performance of DQL-RMS versus AT80 within the simulated market. Again, the horizontal axis 1102 represents operating time (in months). As shown by the upper curve 1104, DQL-RMS initially achieves revenue comparable to AT80, as shown by the lower curve 1106, which is below the DP-RMS benchmark. However, over the course of the first year (i.e. a single reservation horizon), DQL-RMS learns about the market, and increases revenues to eventually outperform DP-RMS against the same competitor. In particular, DQL-RMS achieves 102.5% of benchmark revenue, and forces the competitor's revenue down to 80% of the benchmark.

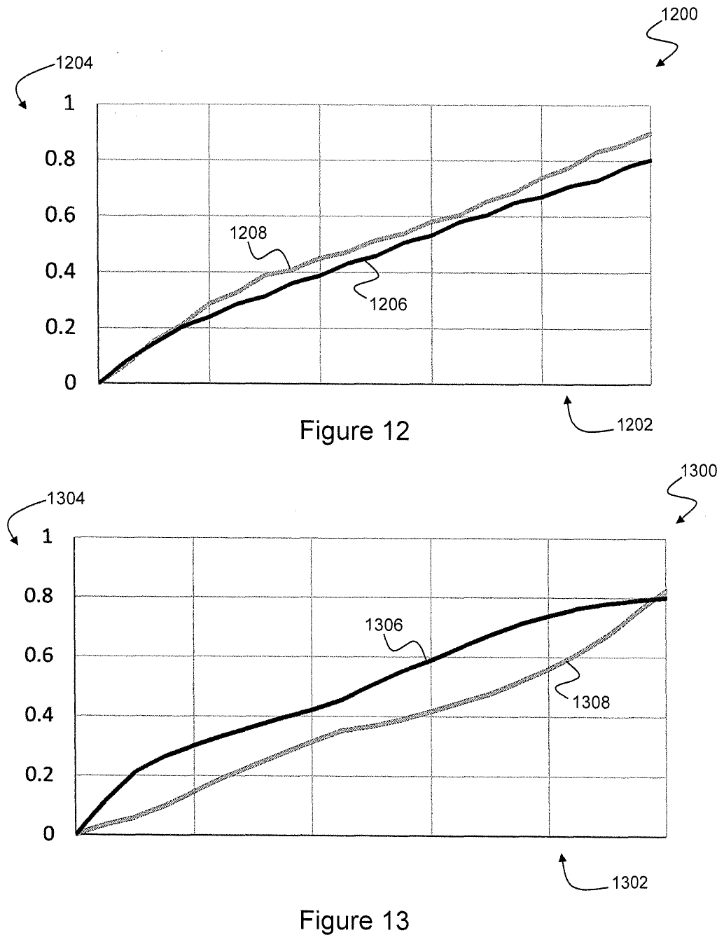

FIG. 12 shows booking curves 1200 further illustrating the way in which DP-RMS competes against AT80. The horizontal axis 1202 represents time, over the full reservation horizon from opening of a flight until departure, while the vertical axis 1204 represents the fraction of seats sold. The lower curve 1206 shows bookings for the airline using AT80 which ultimately achieves 80% of capacity sold. The upper curve 1208 shows bookings for the airline using DP-RMS, which ultimately achieves a higher booking ratio of around 90% of capacity sold. Initially, both AT80 and DP-RMS sell seats at approximately the same rate, however over time DP-RMS consistently outsells AT80, resulting in higher utilisation and higher revenue, as shown in the chart 1000 of FIG. 10.

FIG. 13 shows booking curves 1300 for the competition between DQL-RMS and AT80. Again, the horizontal axis 1302 represents time, over the full reservation horizon from opening of a flight until departure, while the vertical axis 1304 represents the fraction of seats sold. The upper curve 1306 shows bookings for the airline using AT80 which, again, ultimately achieves 80% of capacity sold. The lower curve 1308 shows bookings for the airline using DQL-RMS. In this case, AT80 consistently maintains a higher sales fraction, right up until the final DCP. In particular, during the first 20% of the reservation horizon AT80 initially sells seats at a higher rate than DQL-RMS, rapidly reaching 30% of capacity, at which point the airline using DQL-RMS has sold only about half the number of seats. Throughout the next 60% of the reservation horizon, AT80 and DQL-RMS sells seats at approximately the same rate. During the final 20% of the reservation horizon, however, DQL-RMS sells seats at a considerably higher rate than AT80, eventually achieving a slightly higher utilisation, along with significantly higher revenues, as shown in the chart 1100 of FIG. 11.

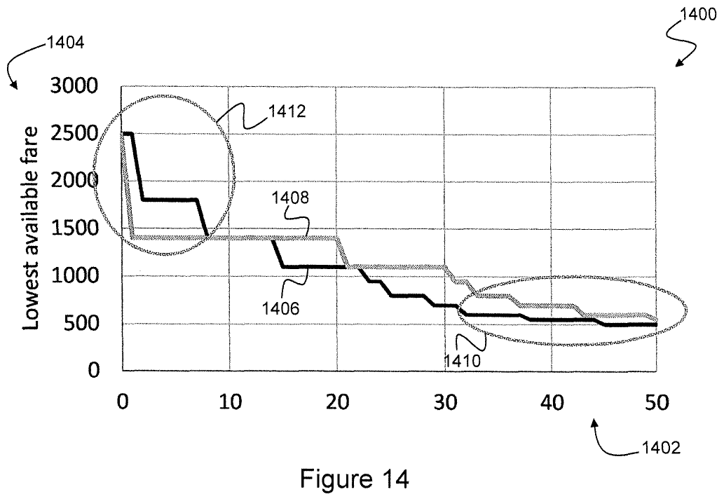

Further insight into the performance of DQL-RMS is provided in FIG. 14, which shows a chart 1400 illustrating the effect of fare policies selected by DP-RMS and DQL-RMS in competition with each other in the simulated market. The horizontal axis 1402 represents the time to departure, in weeks, i.e. the time at which bookings open is represented by the far right-hand side of the chart 1400, and time progress to the day of departure at the far left. The vertical axis 1404 represents the lowest fare in the policies selected by each revenue management approach over time, as a single-valued proxy for the full fare policies. The curve 1406 shows the lowest available fare set by DP-RMS, while the curve 1408 shows the lowest available fare set by DQL-RMS.

As can be seen, in the region 1410 representing the initial sales period, DQL-RMS sets generally higher fare price-points than DP-RMS (i.e. the lowest available fare is higher). The effect of this is to encourage low-yield (i.e. price-sensitive) consumers to book with the airline using DP-RMS. This is consistent with the initially higher rate of sales by the competitor in the scenario shown in the chart 1300 of FIG. 13. Over time, lower fare classes are closed by both airlines, and the lowest available fares in policies generated by both DP-RMS and DQL-RMS gradually increase. Towards the time of departure, in the region 1412, the lowest fares available from the airline using DP-RMS rise considerably above those still available from the airline using DQL-RMS. This is the period during which DQL-RMS significantly increases the rate of sales, selling the higher remaining capacity on its flight at higher prices than would have been obtained had the seats been sold earlier in the reservation period. In short, in competition with DP-RMS, DQL-RMS generally closes cheaper fare classes further from departure, but retains more open classes closer to departure. The DQL-RMS algorithm thus achieves higher revenue by learning about behaviours in the competitive market, and ‘swamping’ competitors with lower-yield passengers early in the reservation window, and using the capacity thus reserved to sell seats to higher-yield passengers later in the reservation window.

It should be appreciated that while particular embodiments and variations of the invention have been described herein, further modifications and alternatives will be apparent to persons skilled in the relevant arts. In particular, the examples are offered by way of illustrating the principles of the invention, and to provide a number of specific methods and arrangements for putting those principles into effect. In general, embodiments of the invention rely upon providing technical arrangements whereby reinforcement learning techniques, and in particular Q-learning and/or deep Q-learning approaches, are employed to select actions, namely the setting of pricing policies, in response to observations of a state of a market, and rewards received from the market in the form of revenues. The state of the market may include available inventory of a perishable commodity, such as airline seats, and a remaining time period within which the inventory must be sold. Modifications and extensions of embodiments of the invention may include the addition of further state variables, such as competitor pricing information (e.g. the lowest and/or other prices currently offered by competitors in the market) and/or other competitor and market information.

Accordingly, the described embodiments should be understood as being provided by way of example, for the purpose of teaching the general features and principles of the invention, but should not be understood as limiting the scope of the invention.

1. A method of reinforcement learning for a resource management agent in a system for managing an inventory of perishable resources having a sales horizon, while seeking to optimize revenue generated therefrom, wherein the inventory has an associated state comprising a remaining availability of the perishable resources and a remaining period of the sales horizon, the method comprising:
generating a plurality of actions, each action comprising publishing data defining a pricing schedule in respect of the perishable resources remaining in the inventory;
receiving, responsive to the plurality of actions, a corresponding plurality of observations, each observation comprising a transition in the state associated with the inventory and an associated reward in a form of revenues generated from sales of the perishable resources;
storing the received observations in a replay memory store;
periodically sampling, from the replay memory store, a randomized batch of observations according to a prioritized replay sampling algorithm wherein, throughout a training epoch, a probability distribution for selection of observations within the randomized batch of observations is progressively adapted from a distribution favoring selection of observations corresponding with transitions close to a terminal state towards a distribution favoring selection of observations corresponding with transitions close to an initial state; and
using each randomized batch of observations to update weight parameters of a neural network that comprises an action-value function approximator of the resource management agent, such that when provided with an input inventory state and an input action, an output of the neural network more closely approximates a true value of generating the input action while in the input inventory state,
wherein the neural network may be used to select each of the plurality of actions generated depending upon a corresponding state associated with the inventory.

2. The method of claim 1 wherein the neural network is a deep neural network.

3. The method of claim 1 further comprising initializing the neural network by:
determining a value function associated with a revenue management system, wherein the value function maps states associated with the inventory to corresponding estimated values;
translating the value function to a corresponding translated action-value function adapted to the resource management agent, wherein the translation comprises matching a time step size to a time step associated with the resource management agent and adding action dimensions to the value function;
sampling the translated action-value function to generate a training data set for the neural network; and
training the neural network using the training data set.

4. The method of claim 1 further comprising:
configuring the resource management agent for switching between action-value function approximation using the neural network and a Q-learning approach based upon a tabular representation of the action-value function, wherein switching comprises:
for each state and action, computing a corresponding action value using the neural network, and populating an entry in an action-value look-up table with the corresponding action value; and
switching to a Q-learning operation mode using the action-value look-up table.

5. The method of claim 4 wherein switching further comprises:
sampling the action-value look-up table to generate a training data set for the neural network;
training the neural network using the training data set; and
switching to a neural network function approximation operation model using the trained neural network.

6. The method of claim 1 wherein the generated actions are transmitted to a market simulator, and the observations are received from the market simulator.

7. The method of claim 6 wherein the market simulator comprises a simulated demand generation module, a simulated reservation system, and a choice simulation module.

8. The method of claim 7 wherein the market simulator further comprises one or more simulated competing inventory systems.

9. A system for managing an inventory of perishable resources having a sales horizon, while seeking to optimize revenue generated therefrom, wherein the inventory has an associated state comprising a remaining availability of the perishable resources and a remaining period of the sales horizon, the system comprising:
a computer-implemented resource management agent module;
a computer-implemented neural network module comprising an action-value function approximator of the computer-implemented resource management agent module;
a replay memory store; and
a computer-implemented learning module,
wherein the computer-implemented resource management agent module is configured to:
generate a plurality of actions, each action being determined by querying the computer-implemented neural network module using a current state associated with the inventory and comprising publishing data defining a pricing schedule in respect of perishable resources remaining in the inventory;
receive, responsive to the plurality of actions, a corresponding plurality of observations, each observation comprising a transition in the state associated with the inventory and an associated reward in a form of revenues generated from sales of the perishable resources; and
store, in the replay memory store, the received observations,
wherein the computer-implemented learning module is configured to:
periodically sample, from the replay memory store, a randomized batch of observations according to a prioritized replay sampling algorithm wherein, throughout a training epoch, a probability distribution for selection of observations within the randomized batch of observations is progressively adapted from a distribution favoring selection of observations corresponding with transitions close to a terminal state towards a distribution favoring selection of observations corresponding with transitions close to an initial state; and
use each randomized batch of observations to update weight parameters of the computer-implemented neural network module, such that when provided with an input inventory state and an input action, an output of the computer-implemented neural network module more closely approximates a true value of generating the input action while in the input inventory state.

10. The system of claim 9 wherein the computer-implemented neural network module comprises a deep neural network.

11. The system of claim 9 further comprising:
a computer-implemented market simulator module,
wherein the computer-implemented resource management agent module is configured to transmit the generated actions to the computer-implemented market simulator module, and to receive the corresponding observations from the computer-implemented market simulator module.

12. The system of claim 11 wherein the computer-implemented market simulator module comprises a simulated demand generation module, a simulated reservation system, and a choice simulation module.

13. The system of claim 12 wherein the computer-implemented market simulator module further comprises one or more simulated competing inventory systems.

14. A computing system for managing an inventory of perishable resources having a sales horizon, while seeking to optimize revenue generated therefrom, wherein the inventory has an associated state comprising a remaining availability of the perishable resources and a remaining period of the sales horizon, the computing system comprising:
a processor;
at least one memory device coupled to the processor; and
a communications interface coupled to the processor,
wherein the at least one memory device contains a replay memory store and a plurality of instructions which, when executed by the processor, cause the computing system to implement a method comprising:
generating a plurality of actions, each action comprising publishing, via the communications interface, data defining a pricing schedule in respect of the perishable resources remaining in the inventory;
receiving, via the communications interface and responsive to the plurality of actions, a corresponding plurality of observations, each observation comprising a transition in the state associated with the inventory and an associated reward in a form of revenues generated from sales of the perishable resources;
storing the received observations in the replay memory store;
periodically sampling, from the replay memory store, a randomized batch of observations according to a prioritized replay sampling algorithm wherein, throughout a training epoch, a probability distribution for selection of observations within the randomized batch of observations is progressively adapted from a distribution favoring selection of observations corresponding with transitions close to a terminal state towards a distribution favoring selection of observations corresponding with transitions close to an initial state; and
using each randomized batch of observations to update weight parameters of a neural network that comprises an action-value function approximator of a resource management agent, such that when provided with an input inventory state and an input action, an output of the neural network more closely approximates a true value of generating the input action while in the input inventory state,
wherein the neural network may be used to select each of the plurality of actions generated depending upon a corresponding state associated with the inventory.

15. A non-transitory computer-readable storage medium comprising instructions that, upon execution by a processor of a computing system, cause the computing system to manage an inventory of perishable resources having a sales horizon, the instructions comprising:
generate a plurality of actions, each action comprising publishing data defining a pricing schedule in respect of the perishable resources remaining in the inventory;
receive, responsive to the plurality of actions, a corresponding plurality of observations, each observation comprising a transition in the state associated with the inventory and an associated reward in a form of revenues generated from sales of the perishable resources;
store the received observations in a replay memory store;
periodically sample, from the replay memory store, a randomized batch of observations according to a prioritised replay sampling algorithm wherein, throughout a training epoch, a probability distribution for selection of observations within the randomized batch of observations is progressively adapted from a distribution favoring selection of observations corresponding with transitions close to a terminal state towards a distribution favoring selection of observations corresponding with transitions close to an initial state; and
use each randomized batch of observations to update weight parameters of a neural network that comprises an action-value function approximator of a resource management agent, such that when provided with an input inventory state and an input action, an output of the neural network more closely approximates a true value of generating the input action while in the input inventory state,
wherein the neural network may be used to select each of the plurality of actions generated depending upon a corresponding state associated with the inventory.
